(19) United States
(12) Patent Application Publication
(10) Pub. No.: US 2017/0236445 A1
(43) Pub. Date: Aug. 17, 2017

(54) INTERACTIVE ACTIVITIES FOR ENVIRONMENTAL RESOURCE SAVING

(71) Applicant: INTELEN, INC, New York, NY (US)

(72) Inventors: Vassilis NIKOLOPOULOS, Maroussi (GR); Konstantinos STAIKOS, Maroussi (GR)

(21) Appl. No.: 15/518,754

(22) PCT Filed: Oct. 16, 2014
(86) PCT No.: PCT/EP2014/072218

§ 371 Date: Apr. 12, 2017

(51) Int. Cl. G09B 19/00; A63F 13/5375; G06Q 10/06; A63F 13/65; A63F 13/67; A63F 13/46; G09B 7/00

(52) U.S. Cl. CPC G09B 19/00; A63F 13/46; A63F 13/5375; G09B 7/00; A63F 13/65; A63F 13/67; G06Q 10/06393

(57) ABSTRACT

Methods and devices for conducting environmental consciousness interactive activities to save on environmental resources are disclosed. IN examples described, a centralized electronic administration platform and electronic user access devices are provided. Activity types are selected and initial activity parameteres are set up for the selected activity types. Then thresholds are set up for activity related key performance indicators (KPIs). The activities are launched and user interaction data is collected at the electronic user access devices. The user interaction data is correlated with each activity related KPI at the centralized electronic administration platform to generate an activity related KPI value. A task based workflow engine is launched at the centralized electronic administration platform to implement at least an algorithm to modify the activity parameters when an activity related KPI vlaue is below the corresponding KPI threshold. The activity is modified based on the modified activity parameters until all the activity related KPI values are above the corresponding KPI thresholds.

### FIELD OF THE INVENTION

The present disclosure relates to energy efficiency and more specifically to devices, platforms and methods for saving environmental resources.

### BACKGROUND

The number of organizations desiring to promote energy efficient behavior to their buildings' occupants increases with time. However, activities related to energy efficiency are often one-off activities and their results are neither sustainable nor measurable.

The question then becomes how to effectively affect human behavior relevant to environmental resource, e.g. energy, efficiency in a way that yields sustainable results. To that end, techniques have been offered to better analyze and map human behaviors relating to building consumptions. Correlating human behavioral inputs with energy consumption as well as with other building metadata and environmental factors, such as weather information, and analyzing this information using behavioral science models, has led to the development of behavioral learning systems that can be used by organizations to promote efficiency, raise awareness on environmental and energy efficiency issues and spread knowledge on related topics.

Behavioral approaches apply behavior analysis and systems analysis to human performance in organizations. To do so, combined techniques have been implemented from both organizational management and empowerment and organizational psychology. By treating each occupant or user as an individual and thus in order to accomplish it, it is important to offer solutions as personalized as possible. However, it is also important to engage the users and provide content that is easy and achieves high participation and engagement as well as efficient and sustainable environmental resource savings.

There is a need for a platform that at least partially solves the aforementioned problems.

### SUMMARY

In a first aspect, a method of conducting an environmental consciousness interactive activity to save environmental resources is disclosed. The method comprises: providing a centralized electronic administration platform; providing an electronic user access device; selecting an activity type from a plurality of activity types stored with the centralized electronic administration platform; setting up initial activity parameters for said selected activity type based on information from past activities stored with the centralized electronic administration platform; setting up thresholds for a plurality of activity related key performance indicators (KPIs); launching an activity from the selected activity type based on said initial activity parameters; collecting user interaction data at the electronic user access device; correlating said user interaction data with each activity related KPI at the centralized electronic administration platform to generate an activity related KPI value; comparing said activity related KPI value with the corresponding threshold at the centralized electronic administration platform; launching a task based workflow engine at the centralized electronic administration platform to implement at least an algorithm to modify the activity parameters when an activity related KPI value is below the corresponding KPI threshold; modifying the activity based on the modified activity parameters until all the activity related KPI values are above the corresponding KPI thresholds.

By measuring the thresholds and launching the task based workflow engine at the centralized electronic administration platform it is possible to implement algorithms that modify the activity parameters when an activity related metric KPI value is below the corresponding metric KPI threshold. This allows for optimizing the success rate of the environmental consciousness interactive activities and, consequently, more environmental resources may be saved.

In some examples launching the activity comprises providing the user from the centralized electronic administration platform a plurality of tips, requests and commitments at the electronic user access device requiring user interaction responses. Each activity may comprise different sets of tips, requests and commitments. Furthermore, each set of tips, requests and commitments may be customized for each activity, user or group of users based on resource saving goals set as activity parameters or based on past activity or user interaction data.

In some examples, the at least one KPI may be an index corresponding to the ratio of tips accessed at the electronic user access device by the user divided by the amount of tips sent by the centralized electronic administration platform. The tips accessed at the electronic user access device by the user may be an indication of a user's awareness, participation or knowledge metrics related to the activity. Therefore measuring the accessed tips may provide an indication about the user's behavior with respect to the aforementioned metrics.

In some examples, the at least one KPI may be an index corresponding to the faults registered by the user. The term “fault” indicates the accepted or recognized faults by e.g. the sustainability manager. When a player registers a fault, the sustainability manager may be required to correct it. Thus an indirect acceptance of the fault may take place which may legitimize the fault for contributing to the KPI.

In some examples, the at least one KPI may be an index corresponding to the amount of login accesses of the user at the electronic user access device in a given period of time. The login accesses of the user at the electronic user access device by the user may be an indication of a user's engagement or participation metrics related to the activity. Therefore measuring the login accesses may provide an indication about the user's behavior with respect to the aforementioned metrics.

In some examples, the at least one KPI may be an index corresponding to the amount of page views of the user at the electronic user access device in a given period of time. The page views of the user at the electronic user access device by the user may be an indication of a user's engagement or participation metrics related to the activity. Therefore measuring the page views may provide an indication about the user's behavior with respect to the aforementioned metrics.

In some examples, the at least one KPI may be an index corresponding to the amount of correct user interaction responses the user or group of users register at the user access device in response to at least a part of the plurality of requests received from the centralized electronic administration platform. The correct user interaction responses of the user at the electronic user access device by the user may be an indication of a user's knowledge or effectiveness metrics related to the activity. Therefore measuring the correct user interaction responses may provide an indication about the user's behavior with respect to the aforementioned metrics.

In some examples, the at least one KPI may be an index corresponding to the actual amount of environmental resources saved during the activity divided by a goal amount set by the centralized electronic administration platform in the initial activity parameters. The environmental resources saved by the user as registered at the electronic user access device may be an indication of a user's effectiveness metric related to the activity. Therefore measuring the environmental resources saved by the user may provide an indication about the user's behavior with respect to the aforementioned metric.

In some examples the at least one KPI may be an index corresponding to the proportion of interactions registered in the electronic user access device by the user with respect to the total number of users linked with said user during the activity at the centralized electronic administration platform. The proportion of interactions registered in the electronic user access device may be an indication of a user's influence metric related to the activity. Therefore measuring the proportion of interactions registered in the electronic user access device may provide an indication about the user's behavior with respect to the aforementioned metric.

In some examples, the task based workflow engine may implement a level of difficulty algorithm in response to at least one KPI falling below the corresponding threshold during the activity to modify the level of difficulty of the activity for said user or group of users. A level of difficulty algorithm may receive the failing KPI and generate a new set of tips, requests and commitments having a level of difficulty lower than the previous one. For that purpose, all tips, requests and commitments stored at the centralized electronic administration platform are associated with a level of difficulty. Accordingly, all users are associated with a level of skill. Each user level of skill may be associated with a level of difficulty for the initial parameters. The activity parameters may therefore be changed during the activity period, if the level of skill measured with the corresponding KPI appears to be lower than the one initially perceived.

In some examples, the task based workflow engine may implement a motivation algorithm to trigger the user or group of users to increase the frequency of access in the user access device during the activity. Motivators may be sent in order to trigger the user and bring him back to the activity. Example motivators may be the user friends' progress, messages to enhance competition between users of the same group etc.

In some examples, the task based workflow engine implements a personalization algorithm to provide the user more personalized content based on the profile of the user and past data collected from previous activities. Providing more personalized content may increase the user's interactions or interest to the activity. In some examples, the platform may send to the user customized tips according to the specific activity. For example, if water bill savings fall, user may get more tips about water consumption reduction.

In another aspect, an electronic administration platform is disclosed. The platform may comprise an activities module, comprising a memory for storing a plurality of activity types. Furthermore, the platform may comprise a parameters module, comprising a memory for storing parameters for each activity type. Furthermore, the platform may comprise a users' module, configured to collect and store user interaction data. The platform may include a processor, said processor configured to: set up thresholds for a plurality of activity related key performance indicators (KPIs); correlate said user interaction data with each activity related KPI at the centralized electronic administration platform to generate an activity related KPI value; and compare said activity related KPI value with the corresponding threshold at the centralized electronic administration platform. The platform may also comprise a workflow engine, configured to implement at least an algorithm to modify the activity parameters when an activity related KPI value is below the corresponding KPI threshold and modify the selected activity based on the modified activity parameters until all the activity related KPI values are above the corresponding KPI thresholds.

In some examples, the electronic administration platform may comprise a centralized module and at least one activity management module. The at least one activity management module may comprise functionality related to a specific activity or a specific group of users whereas the centralized module comprises functionality related to all the activities and all the users. The centralized module may be connected with the memories or databases where all raw data, of all activities, for all users may be recorded. The centralized module may also be responsible for giving access to administrators on each activity to the activity management module. The centralized module may be available to the moderators/administrators of the system or otherwise sustainability/facility managers that are being assigned by the organizations and that may create and manage activities by accessing to the “control center” of the system. The sustainability manager may be able to access in the centralized module through the activity management module all the information he needs about the users and their interactions but he may also be responsible to add to the platform all the required data about the environmental resource consumption such as gas/water bills, measured metrics etc. Moreover, the system may provide him with graphical presentation of indexes (KPIs) corresponding to the various metrics (e.g. awareness, engagement, points, energy etc.)

In some embodiments the at least one activity management module may be remotely coupled to a plurality of environmental resource consumption metering elements for receiving consumption information. For example the activity management module may be remotely coupled to the users' metering devices related to an activity. Thus, the effectiveness of an activity may be measured in real time.

In another aspect, a user access device to conduct an environmental consciousness interactive activity to save environmental resources is disclosed. The device may comprise a communication module, configured to communicate with a centralized electronic administration platform according to examples disclosed herein. Furthermore, the device may comprise an interaction module, configured to display information received from the centralized electronic administration platform and register user responses to be transmitted to the centralized electronic administration platform by the communication module. The device may be in the form of an electronic device, such as a personal computer or a wireless communication device, such as a mobile phone, a tablet etc. The electronic device may provide access to a web site that implements the interaction module or may comprise an application (app) that implements the interaction module.

In some examples the device may further comprise a consumption module configured to be remotely connected to at least one environmental resource consumption metering element. For example the device may comprise an app (the same or another app) that receives information from metering devices associated with the activity.

In some examples, the device may further comprise the at least one environmental resource consumption metering element. For example, the device may comprise an environmental sensor to measure directly or indirectly the environmental resource associated with the activity.

In some examples, the interaction module may comprise functionality for measuring user interaction with the device and/or the activity. For example, the device may measure the number of clicks. In other examples the device may measure the time the user is looking at the device when the app is running to identify the time the user is actually interacting with the app.

In some examples, the device may further comprise a location module, e.g. a geolocation module such as a GPS module, configured to identify the location of the device. The communication module may be configured to transmit location information to the centralized electronic administration platform and receive customized activities and/or tips, requests and commitments based on said location information. For example, based on the location of the user, the platform may associate the user with another group of users or with another activity. For example, when the user is at work the activity may be related to resources of the premises of the company or organization where the user is employed and when the user is at home the activity may be related to resources of the family, the neighborhood or even the city where the user lives. In another example, if a user changes work environment (because he may change job function or because he may change job) then the device may follow this change and provide activities adapted to the new user's situation but based on the past activity experience. For example, this may be achieved by maintaining the user skill level and therefore the difficulty level. This functionality allows for implementing a bottom up approach which may set the user (as a human being) at the center of attention and may follow the user's performance and lifetime progress in various physical entities.

### BRIEF DESCRIPTION OF DRAWINGS

FIG. 1 illustrates a snapshot of the main page of the Admin Panel platform according to an example.

FIG. 2 illustrates a snapshot of the main page of the SM's platform according to an example.

FIG. 3 illustrates a snapshot of the main page of the SM's platform according to another example.

FIG. 4 illustrates a snapshot of the main page of the Users' platform according to an example.

FIG. 5 illustrates a snapshot of the game list of the Users' mobile app according to an example.

FIG. 6 illustrates a Snapshot of the main page of the Users' platform in the mobile app.

FIG. 7 illustrates a metric taxonomy according to an example.

FIG. 8 illustrates a flow path during a planning stage according to an example.

FIG. 9 illustrates a flow path during a main game stage according to an example.

FIG. 10 illustrates a flow path following the beginning of a main game stage where game alterations take place, according to an example.

FIG. 11 illustrates a flow path during a main game stage where data collection takes place, according to an example.

FIG. 12 illustrates a flow path during a reporting stage according to an example.

### DESCRIPTION

The proposed solution is a user-centric approach. It may follow the users' activities across buildings and/or organizations. Therefore, participating users may be engaged with activities throughout the day and/or throughout their professional and/or personal life. Therefore, a user's profile may be generated not only based on the user's organizational behavior (i.e. the user's behavior when the user is engaged in activities as part of his organizational tasks) but also based on the user's personal (e.g. while on the road, at home etc.) behavior that may (or may not) vary from his organizational behavior. The purpose of the proposed solution is not merely to save on environmental resources in a building or organization but to actively motivate and engage the users so that their behavior may inevitably lead to said resource saving.

A centralized electronic administration platform and an electronic user access device with a mobile app may be used in example implementations for that purpose. Organizations may promote energy efficient behavior to their buildings' occupants using the platform and ensure impressive, sustainable results, all while the users are playing fun, engaging activities or are engaged in entertaining and stimulating activities.

The activities provided through the proposed platform may be designed to promote behavioral change through gamification principles. Gamification may be considered as an approach that uses game-based mechanics, aesthetics and game thinking to engage people, motivate action, promote learning and solve problems. Gamification may be considered appropriate for everyday situations and for getting people to do things the ordinarily consider boring. At the same time, the proposed platform deploys a point system, in which the more a player or user interacts with the content the more points he may gain, thus achieving motivation through rewarding. Developing content with tips, quizzes and social media background, the proposed platform may be able to achieve the motivation and the engagement of the player, build environmental commitment and shape a culture that reduces energy costs and serve as a cornerstone for an effective corporate social responsibility (CSR) policy.

The proposed solution allows companies and organizations to easily engage users or players to activities (or “games”) that serve energy consumption reduction needs. This way, building occupants may adopt greener and more efficient behaviors through a fun process and the organization may achieve impressive and long lasting savings.

The proposed solution utilizes elements such as tips, quizzes, points, badges, teams, competition and prizes in order to transform knowledge into an enjoyable and funny journey, a given task into infuse enjoyment. Furthermore, the proposed solution incorporates dynamic tools that integrate social media and other multiple new features in order to make users feel like entering a social classroom and stay there, engaging and interacting.

By consolidating all the above techniques and traits, the proposed solution may constitute a technological solution that may reduce resource consumption, may cause eco-awareness, may deliver significant insights and may optimize the value gained from sustainability.

In one implementation, there are two applications for the electronic user access device, the web app and the mobile app, where every player can create a profile and join a game. The two apps may not share the same interface. However, in both, the game users may be able to read tips, make quizzes and solve real-situation problems about the building's energy consumption and gain points. Each game may have predetermined duration and objectives (e-learning or savings), defined by the administrator of the game. Each building may be split in divisions in which the players belong. Divisions, namely “Green Teams”, may compete against each other. Via a real-time intuitive interface, the building occupants may either just compete with other players to gain special prizes, such as restaurant coupons and vacation packages (e-learning mode), or additionally be taught the correlation between the actions they undertake and the building's energy consumption (also water, oil and gas consumption), providing in this way significant incentives for behavioral changes.

In one implementation the centralized electronic administration platform may comprise a centralized module or Admin Panel platform, and an activity management module or SMs' platform (where SM means Sustainability Manager). The electronic user access device may comprise the aforementioned users' apps, e.g. in the form of a Web profile page and mobile app for players.

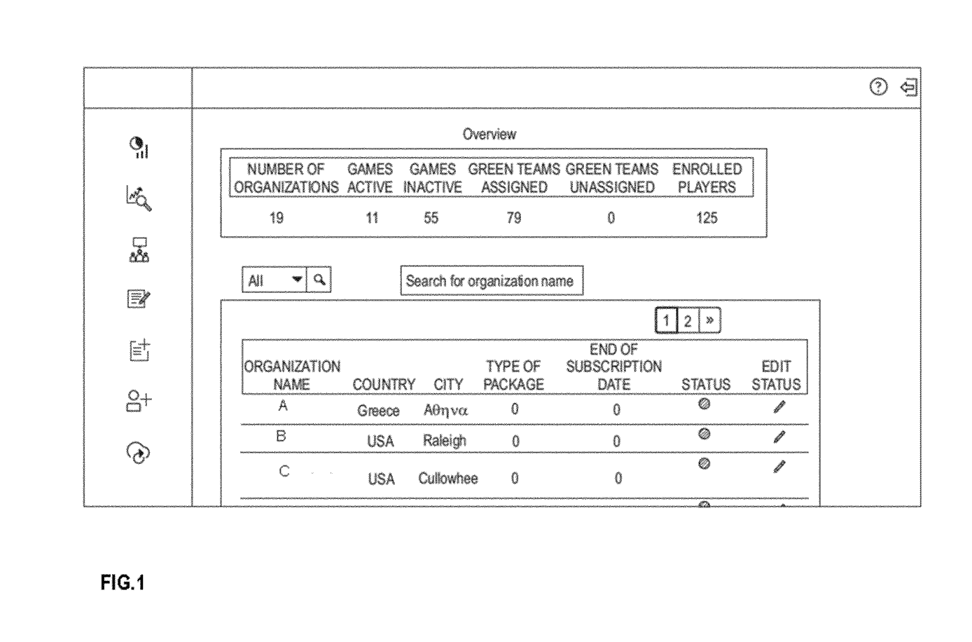

FIG. 1 illustrates a snapshot of the main page of the Admin Panel platform according to an example. The Admin Panel platform may be connected with a database where all raw data, of all games, for all users may be recorded. The Admin Panel platform may also be responsible for giving access to the administrators on each game to the SM's platform. The main page of the Admin Panel platform may comprise information about the number of organizations registered with the platform, the number of active and inactive games, the number of “green teams” or user groups assigned or unassigned and the total number of enrolled players. Further to that, information about each organization, game, group or user may be available through the admin panel platform.

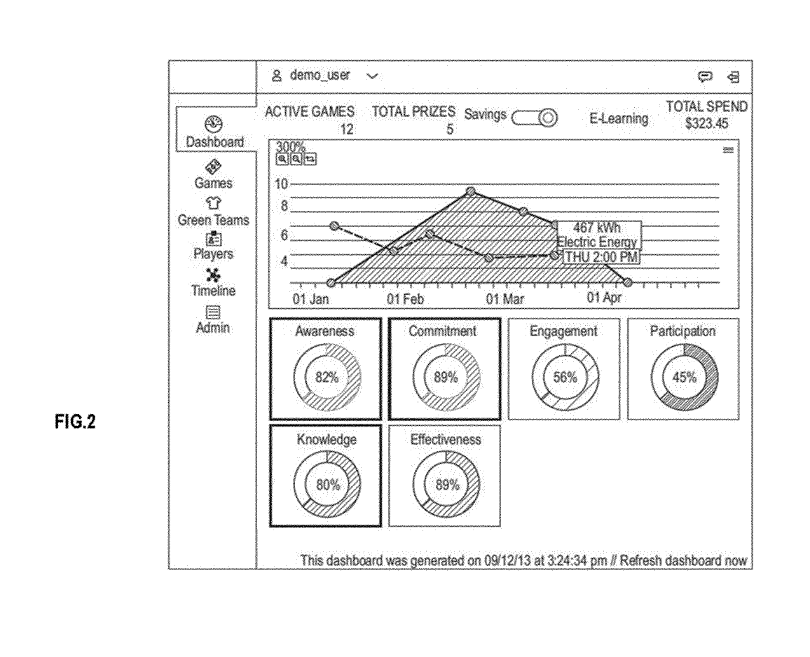

FIG. 2 illustrates a snapshot of the main page of the SM's platform according to an example. The SM platform main page may provide the mode of operation (Savings or E-learning mode) according to the goals of the organization. In the example of FIG. 2, the mode is a e-learning mode. It may provide the progress for each game or set of games as well as percentages of compliance for each metric. In the example of FIG. 2 there are 12 games active for the particular SM, a total of 5 prizes to be claimed by the players. Furthermore the percentages of compliance for each metric or KPI is indicated namely for awareness, commitment, engagement, participation, knowledge and effectiveness.

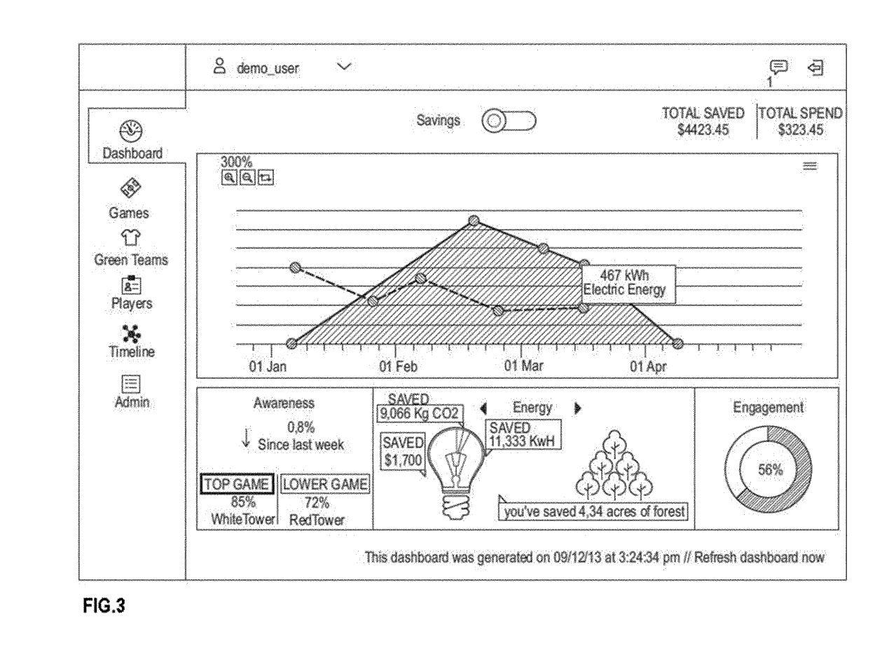

FIG. 3 illustrates a snapshot of the main page of the SM's platform according to another example (a Savings mode). In the example of FIG. 3, the total amount of energy saved (in the corresponding currency, CO₂ reduction, amount of equivalent trees saved or actual energy amount) may be demonstrated. Furthermore it may indicate the top and bottom performers and the overall engagement percentage.

The Admin Panel platform may be available to the moderator/administrator of the system or otherwise sustainability/facility manager, that may be assigned by the organization and he can create and manage games or activities by accessing to a “control center” of the system. The SM may be able to access the dashboard with all the information he may need about the players and their feeds but he may also be responsible to add to the platform all the required data about the energy consumption such as gas/water bills, measured metrics etc. Moreover, the system may provide him with graphical presentation of fields (KPIs) such as awareness, engagement, points, energy etc.

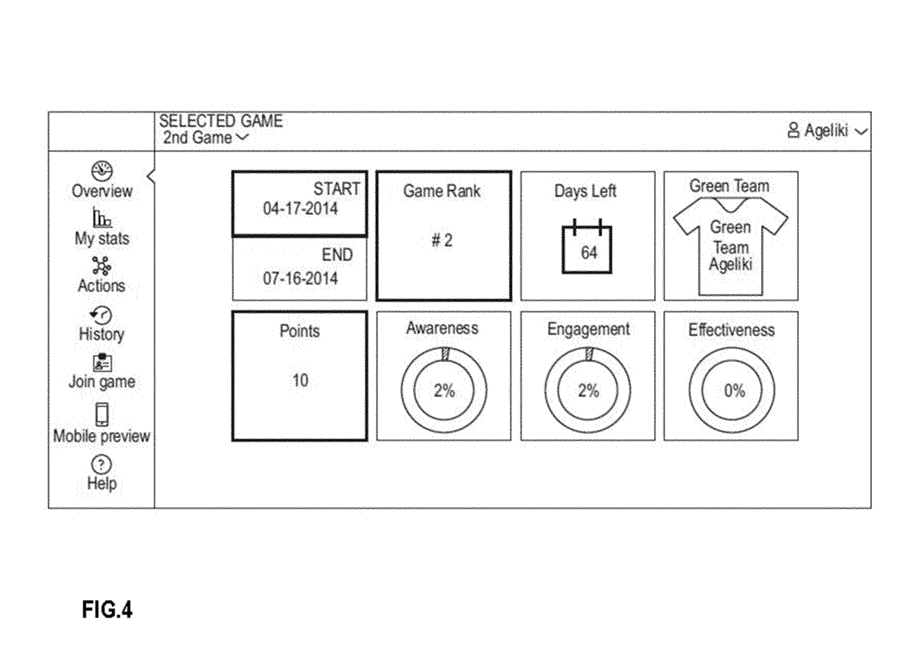

FIG. 4 illustrates a snapshot of the main page of the Users' platform according to an example. The user's platform in FIG. 4 is a web app. It may include information about the user and the current activity or game, such as start and end dates, ranking, group or team where the user belongs, points gained and corresponding KPI or metric values for the user. The web application may be available to the players/users for creating their profiles and thus accessing the games or activities. Through their web-profile players may access details about the game they are participating, such as the leaderboard, competing teams, their team's progress etc., as well as their personal information, which holds a record of all the games they have ever played, their scores, prizes and badges. They may also receive tips and quizzes or questions, take up commitments and register faults. They may also have access to their points, track their progress and view the leaderboard.

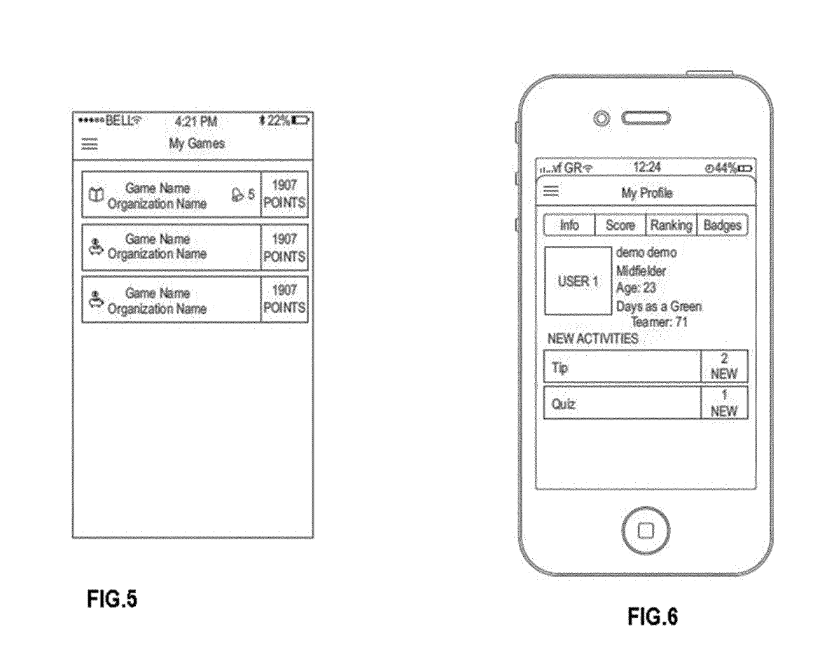

FIG. 5 illustrates a snapshot of the game list of the Users' mobile app according to an example. It may provide a condensed form of the web app. With the mobile application, users may be able to access the game from anywhere and undertake the same actions. Thus a user engaged in more than one activity may view a summary and select from the ongoing activities with a simple view. Accordingly, FIG. 6 illustrates a Snapshot of the main page of the Users' platform in the mobile app. It may, for example, provide overall information of the user and his/her activities.

Systems according to some implementations may utilize metrics that measure user's involvement with the app. More specifically, in the described examples six metrics are used. The platform may record each login, tip read, quiz made, fault resolved or action taken and associate them with the user's profile. The aim of the six metrics may be to collect, analyze and visualize all the relevant data that matter in constructing a the behavioral aspects of environmental consciousness. In some implementations the metrics may be: Awareness, Motivation, Engagement, Knowledge, Influence and Effectiveness.

Apart from typical user interactions with tips or quizzes, the platform may also incorporate social aspects. In some examples, the activities may include new features for surveys, posts and announcements. Three related options in the app may be available to users. The first may be the surveys, respectively, managed either by the platform administrator or by the organization/SM. The second may be the posts made by the players, while the third may be the announcements' field that may be administered by the SMs.

In some implementations connectivity with other Social Media may be anticipated. Furthermore, a news feed may indicate the live-stream actions taken from all the active users, i.e. undertaking a quiz, reading a tip, sharing an article from the board, commit themselves in certain actions etc. The purpose of that feature may be to enhance a real time relative-based update of each user's status. Moreover, news feeds may make players more engaged with the app, increase participation as it may serve the social need of gossip and tracking of friends' actions and activities. Another associated feature may be the incorporation of a chatting function that may allow users to deploy a real time interaction with each other. The goal may be to enhance a social approval effect through the actual feedback of peers. Additionally, text analytics may facilitate the polling of the real opinions of the users as they may be expressed through a non-forced conversation. Further features such as “Nudge”, “Poke”, “Like” etc. may be used to increase user interaction to make user actions more observable by other users.

Another feature may be notifications appearing on the user's screen. However, push notifications arriving to users as email and also as text may also be contemplated. This requires that the system recognizes whether a user is engaged or not in order to send the suitable notification message automatically.

In yet another feature, the apps may support the creation of one or more green communities whose purpose may be to bring people together in order to share their interests and actions. Dates, locations and scope may thus become public to players.

The app may also comprise modules acting as sensors being able to communicate with specific regions. The purpose may be to verify specific actions such as recycling and thus award more points for the user's commitment. In other implementations the modules may actually communicate with metering devices for measuring energy consumption, even in real time.

An activity may be extended in three main stages. During the first stage, which may be considered a planning stage, the game and its contents may be created. The second stage may be considered the game period which starts by the start of the game and ends when the game is over. In this stage, there may be the main workflow in which data may be collected and metrics for each component may be calculated. Also, by the start of the game, according to its characteristics (number of players, duration, scope etc.), it may be categorized and compared to similar previous games. Thus, thresholds may be set and in-time scheduling alteration may be made. In this stage, content customization may also take place. This is critical task due to the fact that by understanding each player and providing the best possible content for his needs, the SM role may be replaced by the platform. This may be made possible by implementing machine learning algorithms and training the system to be more accurate game after game. The last stage may be considered the analysis stage in which insight about the game may be provided. Key factors on this analysis are the correlations of demographic data (players' profile), behavioral data (interaction with the app) and psychographic data (surveys), plotting a story from findings and delivering a high quality report.

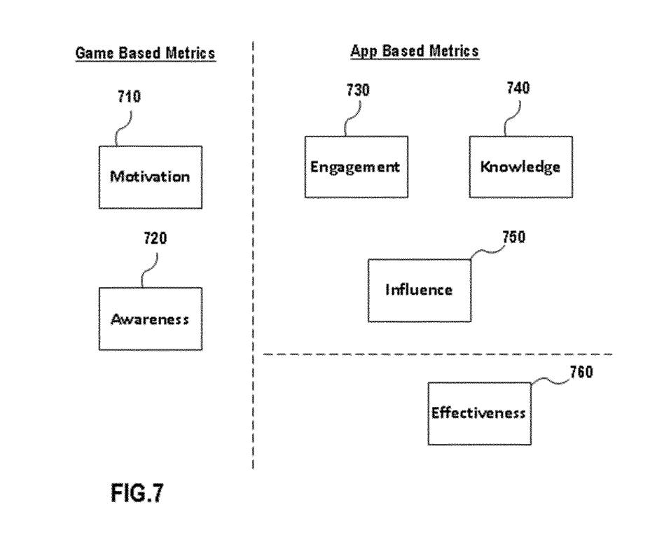

FIG. 7 illustrates a metric taxonomy according to an example. The Game based metrics, according to the example of FIG. 7, are Motivation 710 and Game awareness 720. In the example of FIG. 7, Motivation metrics may be measured by the response of the user to tips, quizzes, commitments and faults registered. Game awareness metrics may be measured by the number of first logins. Now the application (App) based metrics, according to the example of FIG. 7, are Engagement 730, Knowledge 740 and Influence 750. In some examples there may also be an extra metric, Effectiveness 760. Engagement metrics may be measured by the article posts, likes and comments, commitments, faults registered logins and page-views of the user. Knowledge metrics may be measured by the tips, correct answers and article posts of the user. Influence metrics may be measured by the likes and comments, nudges, number of friends and actions views by other users. Finally, the Effectiveness metrics may be measured by the tips, quizzes, faults registered, faults resolved and accomplished savings, as set out in the goals of the game.

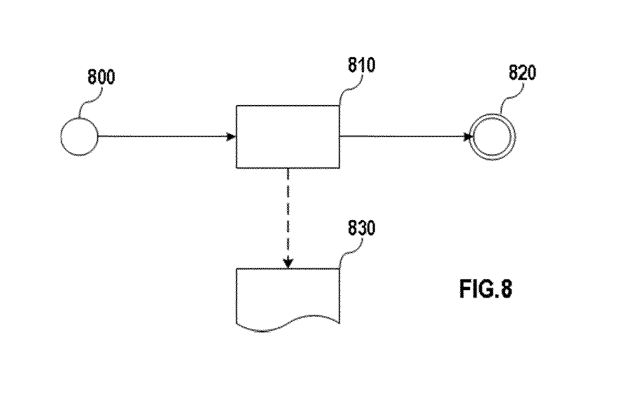

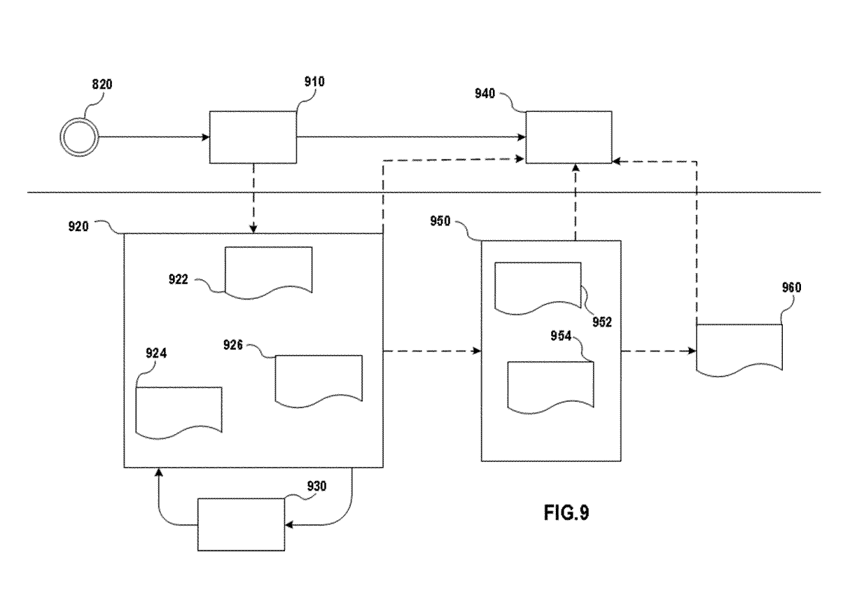

FIG. 8 illustrates a flow path during a planning stage according to an example. In more detail, during the planning stage, when an organization declares interest in participating in the platform in step 800, its account needs to be created and a SM needs to be declared in order to start a game. Further SMs may also be declared. Then, any SM may be able to create and start a game. In each game, the SM may be responsible to create and store the initial parameters, as shown in block 810, such as the game scope, the number of the teams, divisions and buildings and the game duration. These parameters may be essential in order to initialize the platform's algorithms giving them information of what the game is about and how it may schedule it. The SM platform may give the SM the ability to fill standard fields with predefined options in order to describe the scope of the game in block 830. Then the main game stage 820 may begin.

FIG. 9 illustrates a flow path during a main game stage according to an example. Following the beginning of the main game stage 820, as the users register in a game and start playing, the main platform may store their clicks and may monitor all their activity in the app, as illustrated in tracking module 910. On each click the platform may store which page the user has visited, how much time he/she has spent on this page and what actions he/she performed. On the next level, data mining algorithms may try to identify correlations and patterns and shape users' activity profiles as shown in player grouping module 920 with example profiles 922, 924, 926. With exploratory analysis, patterns may be found such as intense activity on certain days of the week, or differences between the most common activities a user usually does when he/she enters the app etc. According to those patterns the platform, in clustering module 930, may cluster the users in different user types segments. After the definition of user types critical issues may emerge when it comes to the classification of every new user or the reassignment of a user in different cluster as the time goes by and he/she may change. Over time, players may be assigned to virtual teams with members having similar profiles to enhance competition between them. The teams may be grouped, in team grouping module 950, and the teams (e.g. illustrated as teams 952, 954 in FIG. 9) may also compete between them during a game 960 or a set of games. The system may be able to correspond in these matters, by training its algorithms and applying artificial intelligence techniques. Related to these methods may be features like peer comparison (compete and compare with similar players), customized scheduling, customized news feed, recommendations etc.

Key activity during the game period may be the calculation of the metrics in metric calculation module 940. Each metric may consist of the interactions which affects it. Each interaction type may be a component in the calculation formula. But all interaction types may not affect in the same way each metric. The interaction types' weights plays critical role in the metric determination and thus are defined dynamically by the platform. By each iteration the machine learning algorithms may learn even more providing more accurate computations. The metric calculation module 940, may receive input by the tracking module 910, the player grouping module 920, the team grouping module 950 and the game 960 to calculate the aforementioned metrics.

By setting the initial parameters, the main platform algorithms may categorize a game according to its characteristics (players, duration, scope) taking into account all the games in the platform's history. According to which cluster the game is be assigned, the platform may calculate estimation about what thresholds should be set. Thresholds may be important, because they may show how the game goal and scope are being achieved. Thus, it may be essential to teach the system to make this kind of decisions (setting thresholds) taking into account the game history of each cluster. At this point, it is important to mention that in order to classify a game according to its attributes, a clustering on all previous games should be run in the first place, thus data from pilot games may be significant and consist the initial training dataset for the algorithms.

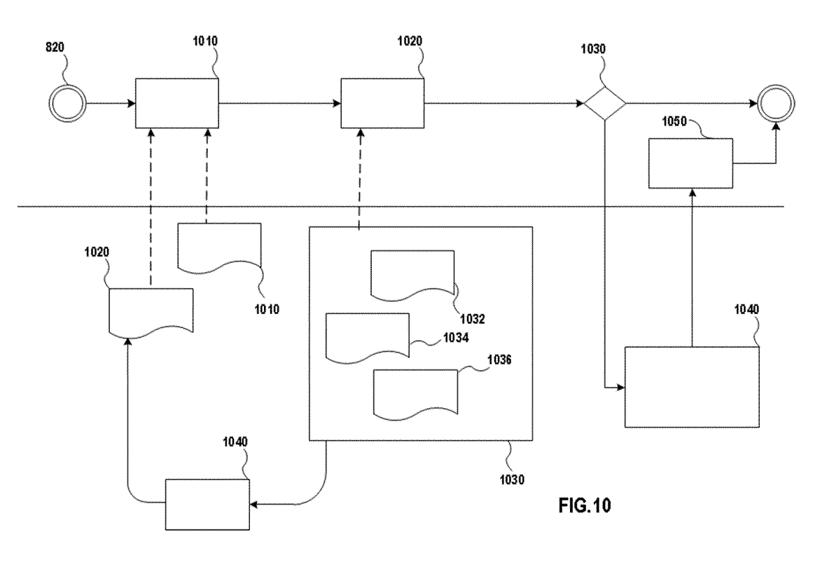

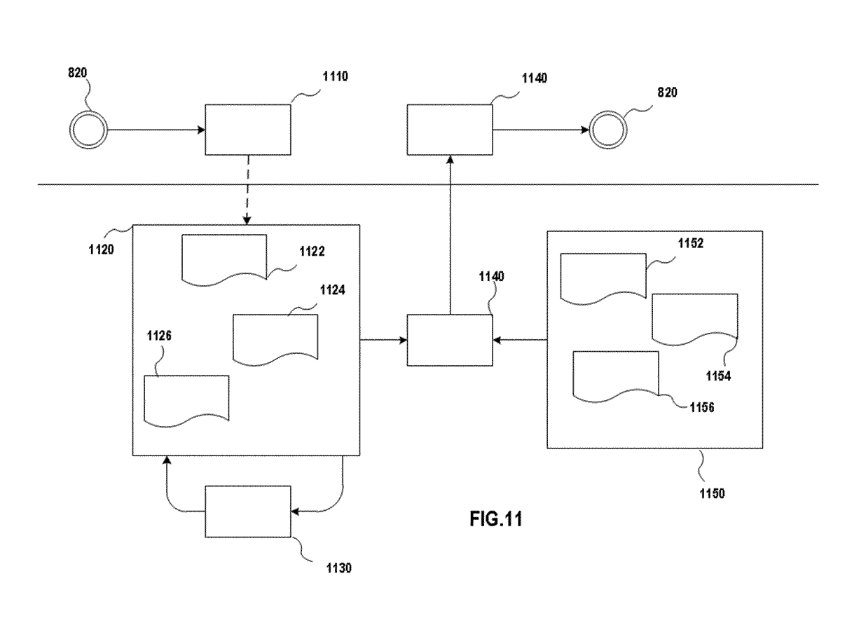

FIG. 10 illustrates a flow path following the beginning of a main game stage 810 where game alterations take place, according to an example. If any alert is triggered, ad hoc game alterations may take place. Those alterations may basically be divided in two main categories. The first one may be about understanding why this alert has been triggered by providing to users surveys and ask them to talk about how they feel. The second may act as motivators in order to change or enhance users' behavior. Typical motivators may be unlocking new prizes, creating a commitment to attract new players, sending email reminders about the game competition etc. The implementation of these triggered events may be based on a task based workflow engine, where after any unusual event (e.g. a metric/KPI that may fall below a specific threshold) that may happen, a series of events may follow in order to restore or enhance the previous condition of the game. More specifically, in game categorization module 1010, the game is categorized based on the results of the planning stage, the available game categories, as received from module 1020, and the current game 1010. After the game is categorized, then the thresholds are set according to the game history analysis, in threshold setting module 1020. The threshold setting module 1020 receives the game category from game categorization module 1010 and the game history from game history module 1030. The game history module 113 includes historical data from previous games (illustrated as stored data of previous games 1032, 1034 and 1036). Furthermore, the game history module 1030 provides information to the game clustering module 1025 that is responsible for clustering the—similar—games. In turn, the game clustering module 1025 provides information to game categories module 1020 that generates the game categories based on the game clusters. Now, the thresholds are monitored throughout the game in module 1035 and if a metric remains under the threshold then no action is taken and the game continues. However, if a metric exceeds the threshold, then the task based workflow engine 1040 is triggered. The task based workflow engine 1040 may provide new parameters for the game, to customize the content for a group or for particular players in a group in game alteration module 1050.

Content customization may depend on two critical factors: The type of content that should be sent to the user and how often this content should be scheduled. In order to answer the first question, it is important to identify the users' knowledge level. On each quiz he/she answers, his knowledge status may be updated and in response giving him/her the next quiz more suited to his/her abilities or skills. Thus, it provides content personalized on the user's needs, thus maximizing his knowledge level estimation. To determine the frequency of each tip/question/commitment etc. to be sent, the users' behavior in the app may be tracked. Finding patterns and correlating them with demographics, the platform may be able to identify user types and according to them provide different scheduling on each type. Applying all the aforementioned, the platform may motivate and engage more the user, challenging him/her and fulfilling its purpose as a persuasive tool, delivering an as personalized as possible service and bringing users one step closer to the app.

When a game is over the main platform may provide to each SM the capability to export all the raw data and some basic aggregated data of the game. FIG. 11 illustrates a flow path during a main game stage where data collection takes place, according to an example. This data collection may refer to players' scores, metrics and interactions, types of players, players' knowledge level and aggregated data for each team and division. More specifically, in performance tracking module 1110, the players' performance may be tracked during the game. Then, in knowledge profile grouping module 1120, the players' knowledge profile may be grouped to generate various groups of player profiles (illustrated as profiles 1122, 1124, 1126). This information may be used by players' clustering module 1130 that corresponds to clustering module 930 of FIG. 9. Furthermore, this information may be used by content classification module 1140 to classify content according to the players' performance category. The content classification module 1140 may further receive information from the content grouping module 1150 that comprises all available content for games, such as tips 1152, quizzes 1154 and commitments 1156. The content classification module 1140 may generate the customized content that is provided to each player during the main game stage 820 by the content provision module 1160.

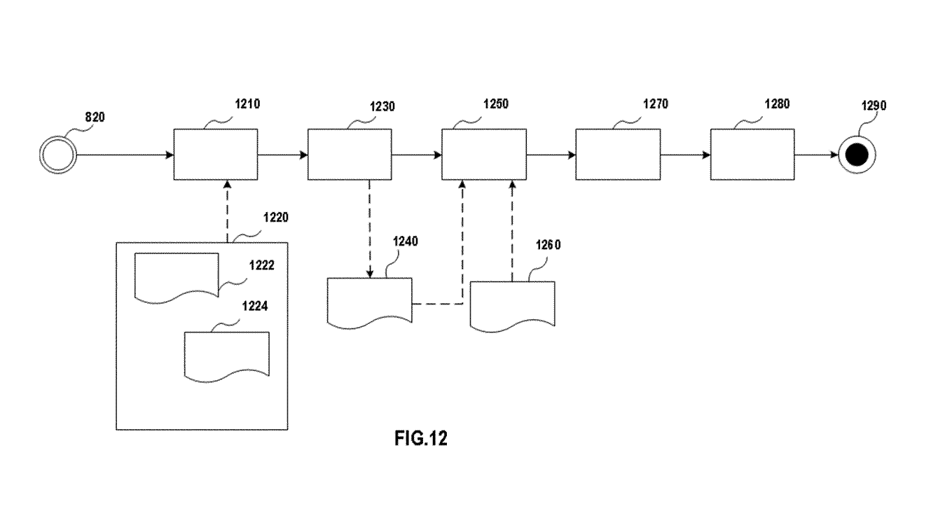

Besides the conclusions each SM may come with these data, the main platform may provide a customized report to the organization. Taking into account not only the individuals' characteristics but also teams′, game's attributes and past similar games, an analyst team may apply behavioral analysis and may seek to explore relationships and patterns, merging them with demographic data. The produced report may be comprised of two main parts: The first part may provide insights and behavioral analytics and the second part may bring comments and remarks of the game overall. FIG. 12 illustrates a flow path during a reporting stage according to an example. More specifically, data extraction module 1210 may receive game information from game data collected for later analysis from the main game stage 820. Furthermore, data extraction module 1210 may receive pre-processed data from pre-process data grouping module 1220. This module may include both raw data 1222 and aggregated data 1224. Then, the extracted data is introduced in data comprehending module 1230. Data comprehending module 1230 generates processed data 1240 and also prepares data to be used by data mining module 1250. Data mining module 1250 may be used to search for correlations and may also receive behavioral data from behavioral data module 1260. Then, diagrams and plots may be generated in plotting module 1270. They may include the virtual story as derived from the game's insights. Finally proposals may be formed by proposal module 1280 based on the generated plots and diagrams. The game analysis may then come to an end at point 1290.

During the implementation of point system and metric's calculation, some problems may emerge. These issues may be summarized in three main categories. The first one is about the technical implementation of the algorithms which provide analytics and insights. The second is referred to the definitions of what may be measured and the design of the ways to do it. Critical factors here may be what data should affect which metric and in which weight. The last issue type is about the reference point on which the platform should calculate either the points or the metrics. In other words, can a player for example achieve 100% Engagement? And if he does, who is being compared to and what happens to other team-players who maybe have not the same amount of content scheduled? All this questions may be critical in order to provide unique user experience and accurate calculations.

To deliver a service, as customized and precise as possible, the platform may implement machine learning techniques. The metrics may be calculated for each user, each team and each game. More specifically, during the game period, for the calculation of Engagement and Awareness, the platform may take into account the players' activity in the app in order to categorize them. Key attributes for this task may be posts and logins for Engagement and the volume of content response for Awareness. At the same time, metrics may be normalized among the players in the same cluster (players with similar behavior). The same procedure may take place for Knowledge, with the difference that here players may be clustered by their knowledge level (correct answers). Clustering the users by specific attributes, and then normalizing the calculated metrics according to cluster centroids and standard deviations, may make the game fair and precise.

Moreover, to calculate the Influence metric, the impact each player has on his team may be measured. To do so, hubs and authorities algorithms may be implemented taking into account the number of likes a player has, by whom and how often he posts in news feed.

Maybe the most valuable metric in energy efficiency terms, is the Effectiveness metric. And this is due to the fact that in every abstract and vague notion as the learning performance, the organizations and the users need results. Effectiveness may correlate Engagement, Awareness and Knowledge with Savings and may operationalize the actual impact the platform may have on consumption reduction.

The following table is an example of the contribution of each interaction type to the respective metric/KPI:

| Metric | Formula | |
|---|---|---|
| Awareness | Y = 0.15(tips | Awareness is about how |
| | read/sent) + 0.3(questions | environmentally aware a player is |
| | read/sent) + 0.3(commitments | and thus commitments is key |
| | engaged/sent) + 0.25(faults | interaction type in this calculation. |
| | per player/total) | |
| Engagement | Y = 0.4(logins per user of last | Key interaction types here are |
| | 30 days/top player's | logins and clicks/pageviews by |
| | logins) + 0.4(PV's per user of | which we can measure if a player |
| | last 30 days/top player | uses the platform a lot and thus is |
| | PV's) + 0.2(faults | engaged. |
| | registered/top player's faults) | |
| Participation | Y = 0.1(tips | In order to calculate the |
| | read/sent) + 0.2(questions | participation metric the platform |
| | read/sent)) + | takes into account the fault a |
| | 0.15(commitments | player voluntarily registers. |
| | engaged/sent) + 0.15(logins | |
| | per user of last 30 days/top | |
| | player's logins) + 0.1(PV's per | |
| | user of last 30 days/top | |
| | player PV's) + 0.3(faults | |
| | registered/top player's faults) | |
| Knowledge | Y = 0.2(tips | As knowledge is all about what a |
| | read/sent) + 0.3(correct | player has learnt by using BiG |
| | questions/read) + 0.3(commitments | app, key interaction type is |
| | fulfilled/engaged) + 0.2(faults | correct answers on questions. |
| | per player resolved/total | Also significant type is |
| | resolved) | commitments because |
| | | experience is the best way to |
| | | learn. |
| Effectiveness | Y = 0.4(savings/goal) + 0.1(tips | Effectiveness is all about |
| | read/sent) + 0.1(questions | resources saving an organization |
| | read/sent) + 0.1(correct | has made during the game |
| | answers/read) + 0.1(commitments | duration. |
| | fulfilled/engaged) + 0.2(faults | |
| | resolved/registered) | |
| Influence | Y = 0.4(likes/followers) + 0.1(comments/ | Users may comment on |
| | followers) + 0.1(nudges/ | something they disagree with, or |
| | followers) + 0.4(profilePV/followers) | nudge someone in order to do |
| | | something. Those interactions |
| | | show that relationships between |
| | | social network nodes (players) |
| | | are not always positive. They can |
| | | have dual meaning. |
| | | Thus, in order to measure |
| | | influence, BiG platform gives |
| | | more weight on likes and profile |
| | | views, which are mostly actions |
| | | on the favour of something (and |
| | | thus the liker adopts it to his |
| | | behaviour) or someone (and thus |
| | | again the liker may adopt |
| | | influencer's behaviour). |

The scaling and calculating algorithms may produce better results by learning through the pilot games. Through training process, the aforementioned weights may be subjected to change as the formulas gain more feedback and adjust each interaction type to new models. Thus the specific weights may differ from the initial parameters which are mentioned above. However, the level of importance on each interaction type may not be affected, and this is because the measurements include what is conceptually important in each metric, and they may be calculated according to what each specific metric means.

Although only a number of particular embodiments and examples of the invention have been disclosed herein, it will be understood by those skilled in the art that other alternative embodiments and/or uses of the invention and obvious modifications and equivalents thereof are possible. Furthermore, the present invention covers all possible combinations of the particular embodiments described. Thus, the scope of the present invention should not be limited by particular embodiments, but should be determined only by a fair reading of the claims that follow.

Further, although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source code, object code, a code intermediate source and object code such as in partially compiled form, or in any other form suitable for use in the implementation of the processes according to the invention. The carrier may be any entity or device capable of carrying the program.

For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal, which may be conveyed via electrical or optical cable or by radio or other means. When the program is embodied in a signal that may be conveyed directly by a cable or other device or means, the carrier may be constituted by such cable or other device or means. Alternatively, the carrier may be an integrated circuit in which the program is embedded, the integrated circuit being adapted for performing, or for use in the performance of, the relevant processes.

1. A method of conducting an environmental consciousness interactive activity to save environmental resource, comprising:
providing a centralized electronic administration platform;
providing an electronic user access device;
selecting an activity type from a plurality of activity types stored with the centralized electronic administration platform
setting up initial activity parameters for said selected activity type based on information from past activities stored with the centralized electronic administration platform;
setting up thresholds for a plurality of activity related key performance indicators (KPIs);
launching an activity from the selected activity type based on said initial activity parameters;
collecting user interaction data at the electronic user access device;
correlating said user interaction data with each activity related KPI at the centralized electronic administration platform to generate an activity related KPI value;
comparing said activity related KPI value with the corresponding threshold at the centralized electronic administration platform;
launching a task based workflow engine at the centralized electronic administration platform to implement at least an algorithm to modify the activity parameters when an activity related KPI value is below the corresponding KPI threshold.
modifying the activity based on the modified activity parameters until all the activity related KPI values are above the corresponding KPI thresholds.

2. The method according to claim 1, wherein launching the activity comprises providing the user from the centralized electronic administration platform a plurality of tips, requests and commitments at the electronic user access device requiring user interaction responses.

3. The method according to claim 2, wherein at least one KPI is an index corresponding to the ratio of tips accessed at the electronic user access device by the user divided by the amount of tips sent by the centralized electronic administration platform.

4. The method according to any of claims 2 to 3, wherein at least one KPI is an index corresponding to the faults registered by the user.

5. The method according to any of claims 2 to 4, wherein at least one KPI is an index corresponding to the amount of login accesses of the user at the electronic user access device in a given period of time.

6. The method according to any of claims 2 to 5, wherein at least one KPI is an index corresponding to the amount of page views of the user at the electronic user access device in a given period of time.

7. The method according to any of claims 2 to 6, wherein at least one KPI is an index corresponding to the amount of correct user interaction responses the user or group of users register at the user access device in response to at least a part of the plurality of requests received from the centralized electronic administration platform.

8. The method according to any of claims 2 to 7, wherein at least one KPI is an index corresponding to the actual amount of environmental resources saved during the activity divided by a goal amount set by the centralized electronic administration platform in the initial activity parameters.

9. The method according to any of claims 2 to 8, wherein at least one KPI is an index corresponding to the proportion of interactions registered in the electronic user access device by the user with respect to the total number of users linked with said user during the activity at the centralized electronic administration platform.

10. The method according to any of the above claims, wherein the task based workflow engine implements a level of difficulty algorithm in response to at least one KPI falling below the corresponding threshold during the activity to modify the level of difficulty of the activity for said user or group of users.

11. The method according to any of the above claims, wherein the task based workflow engine implements a motivation algorithm to trigger the user or group of users to increase the frequency of access in the user access device during the activity.

12. The method according to any of the above claims wherein the task based workflow engine implements a personalization algorithm to provide the user more personalized content based on the profile of the user and past data collected from previous activities.

13. An electronic administration platform comprising:
an activities module, comprising a memory for storing a plurality of activity types;
a parameters module, comprising a memory for storing parameters for each activity type;
a users module, configured to collect and store user interaction data;
a processor, said processor configured to
set up thresholds for a plurality of activity related key performance indicators (KPIs);
correlate said user interaction data with each activity related KPI at the centralized electronic administration platform to generate an activity related KPI value;
compare said activity related KPI value with the corresponding threshold at the centralized electronic administration platform;
a workflow engine configured to implement at least an algorithm to modify the activity parameters when an activity related KPI value is below the corresponding KPI threshold and modify the selected activity based on the modified activity parameters until all the activity related KPI values are above the corresponding KPI thresholds.

14. The electronic administration platform comprising:
a centralized module; and
at least one activity management module,
wherein the at least one activity management module comprises functionality related to a specific activity or a specific group of users whereas the centralized module comprises functionality related to all the activities and all the users.

15. The electronic administration platform according to claim 14, wherein the at least one activity management module is remotely coupled to a plurality of environmental resource consumption metering elements for receiving consumption information.

16. A device to conduct an environmental consciousness interactive activity to save environmental resources, comprising:
a communication module, configured to communicate with a centralized electronic administration platform according to claims 13 to 15;
an interaction module, configured to display information received from the centralized electronic administration platform and register user responses to be transmitted to the centralized electronic administration platform by the communication module.

17. The device according to claim 16, further comprising a consumption module configured to be remotely connected to at least one environmental resource consumption metering element.

18. The device according to claim 17, further comprising the at least one environmental resource consumption metering element

19. The device according to any of claims 16 to 18, wherein the interaction module comprises functionality for measuring user interaction with the device and/or the activity.

20. The device according to any of claims 16 to 19, further comprising a location module, configured to identify the location of the device, wherein the communication module is configured to transmit location information to the centralized electronic administration platform and receive customized activities and/or tips, requests and commitments based on said location information.
